(19) United States
(12) Patent Application Publication
(10) Pub. No.: US 2023/0341503 A1
(43) Pub. Date: Oct. 26, 2023

(54) Connected device control using Multi Access Point Wi-Fi Systems

(71) Applicant: Plume Design, Inc., Palo Alto, CA (US)

(72) Inventors: Rok Vidmar, Ljubljana (SI); William J. McFarland, Portola Valley, CA (US)

(21) Appl. No.: 17/729,594

(22) Filed: Apr. 26, 2022

(51) Int. Cl. G01S 5/02; G01S 5/00; H04W 64/00

(52) U.S. Cl. CPC G01S 5/0278; G01S 5/017; G01S 5/0036; G01S 5/0063; H04W 64/006

(57) ABSTRACT

System and methods include determining a person's physical location based on analyzing Wi-Fi signal data received from a multiple Wi-Fi access point system as part of a distributed Wi-Fi system; and controlling smart devices based on one or more of predetermined settings, machine learned settings, and the person's physical location. The steps can further include determining the person's physical location based on analyzing Wi-Fi client devices that are mobile in the distributed Wi-Fi system.

### FIELD OF THE DISCLOSURE

The present disclosure generally relates to wireless networking systems and methods. More particularly, the present disclosure relates to connected device control using Multi Access Point (AP) Wi-Fi Systems.

### BACKGROUND OF THE DISCLOSURE

Conventional Wi-Fi networks are deployed by users in their residences to provide network connectivity to various devices (e.g., mobile devices, tablets, televisions, Internet of Things (IoT) devices, laptops, media players, and the like). The clients obtain network connectivity from their service provider, e.g., Multiple Systems Operators (MSOs), wireless providers, telecom providers, etc. IoT devices are being deployed as part of the smart environment concept, through which technology is making every day or household tasks more convenient and efficient by utilizing smart devices in an environment, such as a residence, office, or the like. Smart devices are electronic devices generally connected to other devices or networks via different wireless protocols such as Bluetooth, Zigbee, NFC, Wi-Fi, 5G, etc, and the devices include embedded sensors, actuators, processors, and transceivers. Architecture is not universally standardized in smart devices but the most basic architecture typically includes a hardware layer (sensors), a network layer (network devices and servers), and an application layer (interface between the device and the network) through which users can receive and transmit data for monitoring and control. Storage and processing of data is usually restricted at the smart device due to size limitations or economical factors, therefore storage and process of data is usually performed by the network. Smart devices can operate interactively or autonomously, and examples include smart thermostats, smart doorbells, smart locks, smart lighting, smart home entertainment devices, smart televisions, etc. From the client perspective these smart devices require client interface control via either an interfacing mobile device utilizing an application (app), such as a tablet or smart phone, or via a client interface that allows hand-free operation but requires voice recognition or voice client interface (VUI).

The mobile device interfacing method of controlling smart devices requires the client to interface with the mobile device where for trivial actions such as lighting control, does not provide a great deal of convenience over traditional manual methods. Voice recognition has seen issues with missing words or misinterpreting the sentence all together, caused for example by speedy talking or accents. Background noise can also be an issue caused by other people in the location or from other devices operating at the same time as the voice recognition. Also, a client's distance from the device microphone can affect the ability to pick up the command. As smart devices become more commonplace there exists a need to provide a more convenient and more efficient way for clients to interface and control these smart devices.

### BRIEF SUMMARY OF THE DISCLOSURE

The present disclosure includes obtaining a client's physical location based on analyzing Wi-Fi signal data received from a multiple Wi-Fi access point system as part of a distributed Wi-Fi system; and responsive to detecting the client location, controlling smart devices based on predetermined client settings as well as machine learned settings. The method disclosed provides a more convenient and efficient way for clients to interface with smart devices as smart devices are being deployed not only for convenience but are also being deployed for many reasons, including but not limited to security and energy management. The term smart device and IoT device is used synonymously throughout this disclosure.

In various embodiments, the present disclosure includes a method having steps, a system including at least one processor and memory with instructions that, when executed, cause the at least one processor to implement the steps, and a non-transitory computer-readable medium having instructions stored thereon for programming at least one processor to perform the steps. The steps include determining a person's physical location based on analyzing Wi-Fi signal data received from a multiple Wi-Fi access point system as part of a distributed Wi-Fi system; and controlling smart devices based on one or more of predetermined settings, machine learned settings, and the person's physical location.

The steps can further include determining the person's physical location based on analyzing Wi-Fi client devices that are mobile in the distributed Wi-Fi system. The steps can further include determining the person's physical location based on disturbance of Wi-Fi signals between a client device and at least one Access Point (AP) or between two APs in the distributed Wi-Fi system. The machine learned settings can include using historical location data and statistical analysis to learn patterns of Wi-Fi client devices. An identity of the person can be unknown or known and the controlling is specific to the person. The steps can further include correlating a specific user with a specific Wi-Fi client device. The determining can be based on monitoring motion of an associated Wi-Fi client device.

The determining can be based on triangulation of the Wi-Fi signal data from a plurality of access points. The triangulation can be done using one or more of observed Wi-Fi signal strength and observed Wi-Fi time of arrival. The determining can be based on matching of a signal strength vector within a certain margin of error. The determining can be based on matching of a time of arrival vector within a certain margin of error. The determining can be based on matching of a motion disturbance vector within a certain margin of error. The determining can be based at least partially on training with feedback from the person.

The feedback can include one or more of the person indicating their current location at a particular instant, and the person indicating which mobile client devices are associated specifically with them. The machine learned settings can include correlating actions on smart devices with the client's physical location. The controlling smart devices can include turning a smart device on or off. The smart devices can include thermostats and the controlling includes setting based on a presence of users. The controlling smart devices can include changing a state of an entire house when all people leave or a first person arrives.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a distributed Wi-Fi system with cloud-based control and management.

FIG. 2 is a network diagram of differences in the operation of the distributed Wi-Fi system of FIG. 1 relative to a conventional single access point system, a Wi-Fi mesh network, and a Wi-Fi repeater network.

FIG. 3 is a block diagram of a server which may be used in the cloud, in other systems, or standalone.

FIG. 4 is a block diagram of a mobile 300, which may be used for the client device in the distributed Wi-Fi system of FIG. 1 or the like.

FIG. 5 illustrates a household distributed Wi-Fi system 400, utilizing Wi-Fi signal strength data to locate a client using multiple Wi-Fi access points and controlling a smart device in the household from one of the access points.

FIG. 6 is a flowchart of the process as described in the claims for obtaining a client's physical location based on analyzing Wi-Fi signal data received from a multiple Wi-Fi access point system as part of a distributed Wi-Fi system; and responsive to detecting the client location, controlling smart devices.

### DETAILED DESCRIPTION OF THE DISCLOSURE

In various embodiments, the present disclosure relates to systems and methods for connected device control using Multi Access Point Wi-Fi Systems.

Distributed Wi-Fi System

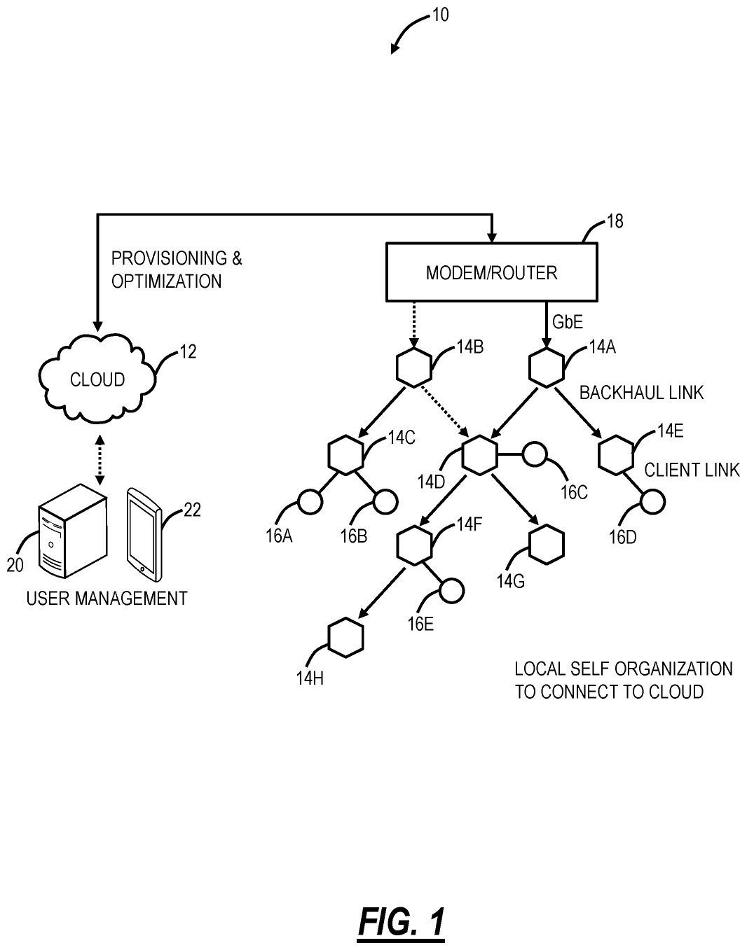

FIG. 1 is a network diagram of a distributed Wi-Fi system 10 with control via a cloud 12 service. The distributed Wi-Fi system 10 can operate in accordance with the IEEE 802.11 protocols and variations thereof. The distributed Wi-Fi system 10 includes a plurality of access points 14 (labeled as access points 14A-14H), which can be distributed throughout a location, such as a residence, office, or the like. That is, the distributed Wi-Fi system 10 contemplates operation in any physical location where it is inefficient or impractical to service with a single access point, repeaters, or a mesh system. As described herein, the distributed Wi-Fi system 10 can be referred to as a network, a system, a Wi-Fi network, a Wi-Fi system, a cloud-based system, etc. The access points 14 can be referred to as nodes, access points, Wi-Fi nodes, Wi-Fi access points, etc. The objective of the access points 14 is to provide network connectivity to Wi-Fi client devices 16 (labeled as Wi-Fi client devices 16A-16E). The Wi-Fi client devices 16 can be referred to as client devices, user devices, clients, Wi-Fi clients, Wi-Fi devices, etc.

In a typical residential deployment, the distributed Wi-Fi system 10 can include between 3 to 12 access points or more in a home. A large number of access points 14 (which can also be referred to as nodes in the distributed Wi-Fi system 10) ensures that the distance between any access point 14 is always small, as is the distance to any Wi-Fi client device 16 needing Wi-Fi service. That is, an objective of the distributed Wi-Fi system 10 can be for distances between the access points 14 to be of similar size as distances between the Wi-Fi client devices 16 and the associated access point 14. Such small distances ensure that every corner of a consumer's home is well covered by Wi-Fi signals. It also ensures that any given hop in the distributed Wi-Fi system 10 is short and goes through few walls. This results in very strong signal strengths for each hop in the distributed Wi-Fi system 10, allowing the use of high data rates, and providing robust operation. Note, those skilled in the art will recognize the Wi-Fi client devices 16 can be mobile devices, tablets, computers, consumer electronics, home entertainment devices, televisions, IoT devices, or any network-enabled device. For external network connectivity, one or more of the access points 14 can be connected to a modem/router 18, which can be a cable modem, Digital Subscriber Loop (DSL) modem, or any device providing external network connectivity to the physical location associated with the distributed Wi-Fi system 10.

While providing excellent coverage, a large number of access points 14 (nodes) presents a coordination problem. Getting all the access points 14 configured correctly and communicating efficiently requires centralized control. This cloud 12 service can provide control via servers 20 that can be reached across the Internet and accessed remotely, such as through an application (“app”) running on a client device 22. The running of the distributed Wi-Fi system 10, therefore, becomes what is commonly known as a “cloud service.” The servers 20 are configured to receive measurement data, to analyze the measurement data, and to configure the access points 14 in the distributed Wi-Fi system 10 based thereon, through the cloud 12. The servers 20 can also be configured to determine which access point 14 each of the Wi-Fi client devices 16 connect (associate) with. That is, in an example aspect, the distributed Wi-Fi system 10 includes cloud-based control (with a cloud-based controller or cloud service in the cloud) to optimize, configure, and monitor the operation of the access points 14 and the Wi-Fi client devices 16. This cloud-based control is contrasted with a conventional operation that relies on a local configuration, such as by logging in locally to an access point. In the distributed Wi-Fi system 10, the control and optimization does not require local login to the access point 14, but rather the client device 22 (or a local Wi-Fi client device 16) communicating with the servers 20 in the cloud 12, such as via a disparate network (a different network than the distributed Wi-Fi system 10) (e.g., LTE, another Wi-Fi network, etc.).

The access points 14 can include both wireless links and wired links for connectivity. In the example of FIG. 1, the access point 14A has an example gigabit Ethernet (GbE) wired connection to the modem/router 18. Optionally, the access point 14B also has a wired connection to the modem/router 18, such as for redundancy or load balancing. Also, the access points 14A, 14B can have a wireless connection to the modem/router 18. The access points 14 can have wireless links for client connectivity (referred to as a client link) and for backhaul (referred to as a backhaul link). The distributed Wi-Fi system 10 differs from a conventional Wi-Fi mesh network in that the client links and the backhaul links do not necessarily share the same Wi-Fi channel, thereby reducing interference. That is, the access points 14 can support at least two Wi-Fi wireless channels—which can be used flexibly to serve either the client link or the backhaul link and may have at least one wired port for connectivity to the modem/router 18, or for connection to other devices. In the distributed Wi-Fi system 10, only a small subset of the access points 14 require direct connectivity to the modem/router 18 with the non-connected access points 14 communicating with the modem/router 18 through the backhaul links back to the connected access points 14.

Distributed Wi-Fi System Compared to Conventional Wi-Fi Systems

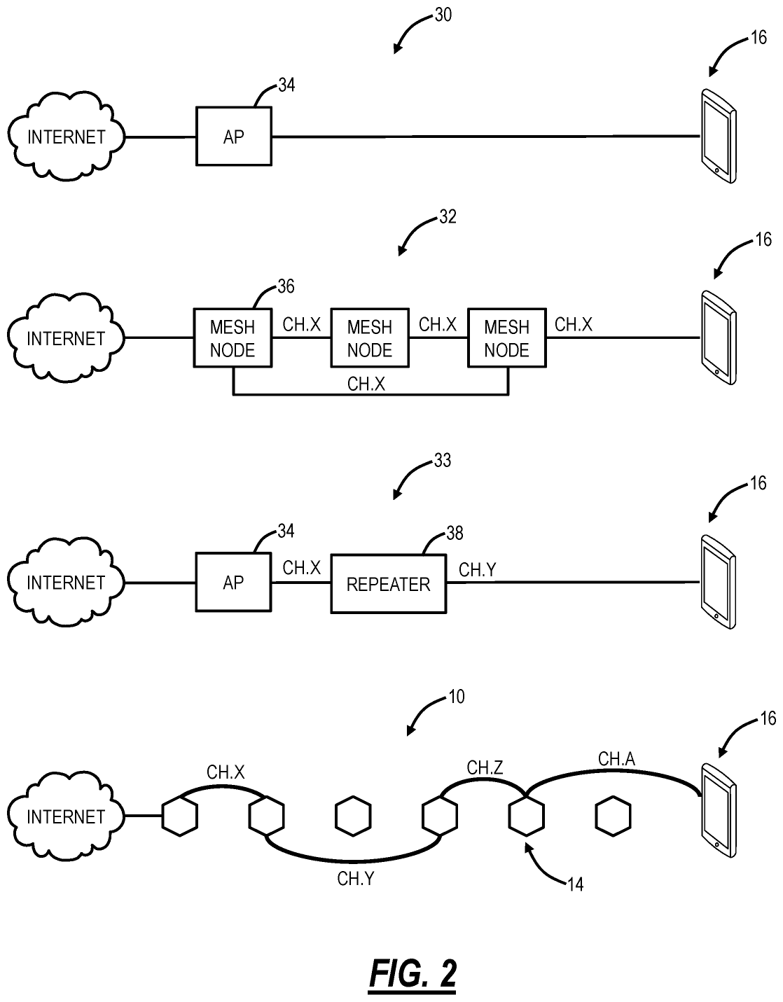

FIG. 2 is a network diagram of differences in the operation of the distributed Wi-Fi system 10 relative to a conventional single access point system 30, a Wi-Fi mesh network 32, and a Wi-Fi repeater network 33. The single access point system 30 relies on a single, high-powered access point 34, which may be centrally located to serve all Wi-Fi client devices 16 in a location (e.g., house). Again, as described herein, in a typical residence, the single access point system 30 can have several walls, floors, etc. between the access point 34 and the Wi-Fi client devices 16. Plus, the single access point system 30 operates on a single channel, leading to potential interference from neighboring systems. The Wi-Fi mesh network 32 solves some of the issues with the single access point system 30 by having multiple mesh nodes 36, which distribute the Wi-Fi coverage. Specifically, the Wi-Fi mesh network 32 operates based on the mesh nodes 36 being fully interconnected with one another, sharing a channel such as a channel X between each of the mesh nodes 36 and the Wi-Fi client device 16. That is, the Wi-Fi mesh network 32 is a fully interconnected grid, sharing the same channel, and allowing multiple different paths between the mesh nodes 36 and the Wi-Fi client device 16. However, since the Wi-Fi mesh network 32 uses the same backhaul channel, every hop between source points divides the network capacity by the number of hops taken to deliver the data. For example, if it takes three hops to stream a video to a Wi-Fi client device 16, the Wi-Fi mesh network 32 is left with only ⅓ the capacity. The Wi-Fi repeater network 33 includes the access point 34 coupled wirelessly to a Wi-Fi repeater 38. The Wi-Fi repeater network 33 is a star topology where there is at most one Wi-Fi repeater 38 between the access point 14 and the Wi-Fi client device 16. From a channel perspective, the access point 34 can communicate to the Wi-Fi repeater 38 on a first channel, Ch. X, and the Wi-Fi repeater 38 can communicate to the Wi-Fi client device 16 on a second channel, Ch. Y.

The distributed Wi-Fi system 10 solves the problem with the Wi-Fi mesh network 32 of requiring the same channel for all connections by using a different channel or band for the various hops (note, some hops may use the same channel/band, but it is not required), to prevent slowing down the Wi-Fi speed. For example, the distributed Wi-Fi system 10 can use different channels/bands between access points 14 and between the Wi-Fi client device 16 (e.g., Channels X, Y, Z, A), and also, the distributed Wi-Fi system 10 does not necessarily use every access point 14, based on configuration and optimization by the cloud 12. The distributed Wi-Fi system 10 solves the problems of the single access point system 30 by providing multiple access points 14. The distributed Wi-Fi system 10 is not constrained to a star topology as in the Wi-Fi repeater network 33, which at most allows two wireless hops between the Wi-Fi client device 16 and a gateway. Also, the distributed Wi-Fi system 10 forms a tree topology where there is one path between the Wi-Fi client device 16 and the gateway, but which allows for multiple wireless hops, unlike the Wi-Fi repeater network 33.

Wi-Fi is a shared, simplex protocol meaning only one conversation between two devices can occur in the network at any given time, and if one device is talking the others need to be listening. By using different Wi-Fi channels, multiple simultaneous conversations can happen simultaneously in the distributed Wi-Fi system 10. By selecting different Wi-Fi channels between the access points 14, interference and congestion are avoided. The server 20 through the cloud 12 automatically configures the access points 14 in an optimized channel hop solution. The distributed Wi-Fi system 10 can choose routes and channels to support the ever-changing needs of consumers and their Wi-Fi client devices 16. The distributed Wi-Fi system 10 approach is to ensure Wi-Fi signals do not need to travel far—either for backhaul or client connectivity. Accordingly, the Wi-Fi signals remain strong and avoid interference by communicating on the same channel as in the Wi-Fi mesh network 32 or with Wi-Fi repeaters. In an example aspect, the servers 20 in the cloud 12 are configured to optimize channel selection for the best client experience.

Cloud-Based Wi-Fi Management

Conventional Wi-Fi systems utilize local management, such as where a client on the Wi-Fi network connects to a designated address (e.g., 192.168.1.1, etc.). The distributed Wi-Fi system 10 is configured for cloud-based management via the servers 20 in the cloud 12. Also, the single access point system 30, the Wi-Fi mesh network 32, and the Wi-Fi repeater network 33 can support cloud-based management as described above. For example, the APs 34 and/or the mesh nodes 36 can be configured to communicate with the servers 20 in the cloud 12. This configuration can be through a software agent installed in each device or the like, e.g., OpenSync. As described herein, cloud-based management includes reporting of Wi-Fi related performance metrics to the cloud 12 as well as receiving Wi-Fi-related configuration parameters from the cloud 12. The systems and methods contemplate use with any Wi-Fi system (i.e., the distributed Wi-Fi system 10, the single access point system 30, the Wi-Fi mesh network 32, and the Wi-Fi repeater network 33, etc.), including systems that only support reporting of Wi-Fi related performance metrics (and not supporting cloud-based configuration).

The cloud 12 utilizes cloud computing systems and methods abstract away physical servers, storage, networking, etc. and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase SaaS is sometimes used to describe application programs offered through cloud computing. A common shorthand for a provided cloud computing service (or even an aggregation of all existing cloud services) is “the cloud.”

### Example Server Architecture

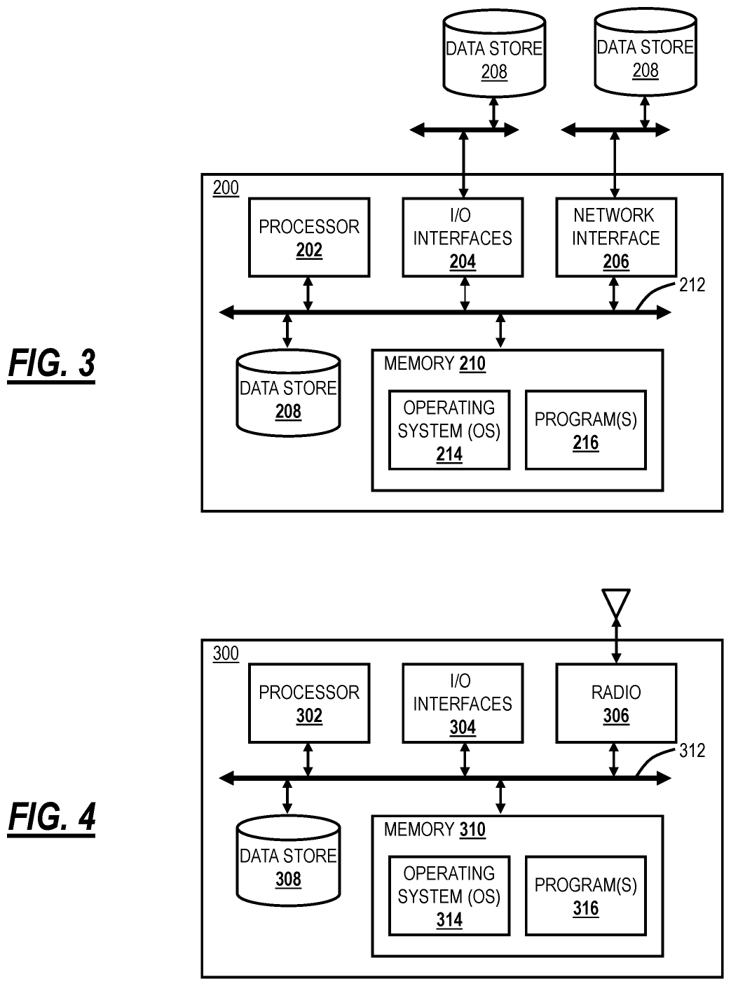

FIG. 3 is a block diagram of a server 200 which may be used in the cloud 12, in other systems, or standalone. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 3 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive client input from and/or for providing system output to one or more devices or components. The client input may be provided via, for example, a keyboard, touchpad, and/or a mouse. System output may be provided via a display device and a printer (not shown). I/O interfaces 204 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 206 may be used to enable the server 200 to communicate on a network, such as the Internet. The network interface 206 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### Example Client Device Architecture

FIG. 4 is a block diagram of a client device 300, which may be used for the client device 22 or the like. The client device 300 can be a digital device that, in terms of hardware architecture, generally includes a processor 302, input/output (I/O) interfaces 304, a radio 306, a data store 308, and memory 310. It should be appreciated by those of ordinary skill in the art that FIG. 4 depicts the client device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a central processing unit (CPU), an auxiliary processor among several processors associated with the client device 300, a semiconductor-based microprocessor (in the form of a microchip or chipset), or generally any device for executing software instructions. When the client device 300 is in operation, the processor 302 is configured to execute software stored within the memory 310, to communicate data to and from the memory 310, and to generally control operations of the client device 300 pursuant to the software instructions. In an embodiment, the processor 302 may include a mobile optimized processor such as optimized for power consumption and mobile applications. The I/O interfaces 304 can be used to receive client input from and/or for providing system output. Client input can be provided via, for example, a keypad, a touch screen, a scroll ball, a scroll bar, buttons, a barcode scanner, and the like. System output can be provided via a display device such as a liquid crystal display (LCD), touch screen, and the like. The I/O interfaces 304 can also include, for example, a serial port, a parallel port, a small computer system interface (SCSI), an infrared (IR) interface, a radio frequency (RF) interface, a universal serial bus (USB) interface, and the like. The I/O interfaces 304 can include a graphical client interface (GUI) that enables a client to interact with the client device 300. Additionally, the I/O interfaces 304 may further include an imaging device, i.e., camera, video camera, etc.

The radio 306 enables wireless communication to an external access device or network. Any number of suitable wireless data communication protocols, techniques, or methodologies can be supported by the radio 306, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g., 3G/4G/5G, etc.); wireless home network communication protocols; proprietary wireless data communication protocols such as variants of Wireless USB; and any other protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 can include one or more software programs, each of which includes an ordered listing of executable instructions for implementing logical functions. In the example of FIG. 3, the software in the memory 310 includes a suitable operating system (O/S) 314 and programs 316. The operating system 314 essentially controls the execution of other computer programs and provides scheduling, input-output control, file and data management, memory management, and communication control and related services. The programs 316 may include various applications, add-ons, etc. configured to provide end-client functionality with the client device 300. For example, example programs 316 may include, but not limited to, a web browser, social networking applications, streaming media applications, games, mapping and location applications, electronic mail applications, financial applications, and the like. In a typical example, the end client typically uses one or more of the programs 316 along with a network.

Obtaining a Client Location from a Distributed Wi-Fi System and Controlling Smart Devices

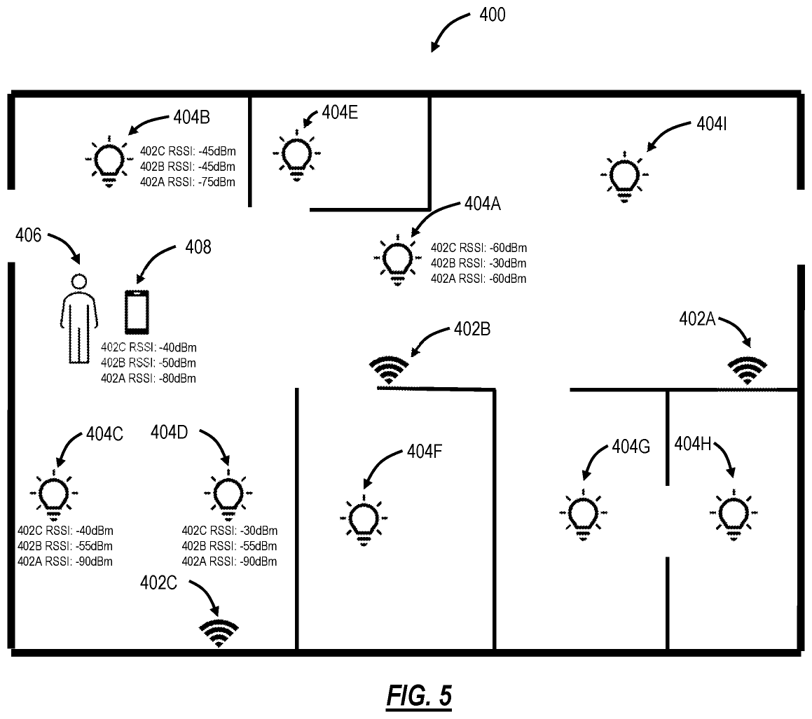

FIG. 5 depicts a household distributed Wi-Fi system 400, consisting of a plurality of access points 402 (labeled as 402A-402C), which are distributed throughout the household. The client 406 and client Wi-Fi device 408 are shown to depict a scenario where the client is actively moving about the household. The client Wi-Fi device 408 can be a smart watch, smart phone, tablet, or any network enabled device that can be worn or carried by the client 406. This distributed system is depicted and described in further detail as a network diagram shown and described in FIG. 1. Note that those skilled in the art will recognize that the number of access points, clients, client Wi-Fi devices, and the configuration of the household can consist of different configurations, which are omitted for illustration purposes. In this illustration the smart devices in the household are depicted as smart lighting 404 (labeled as 404A-404I), however this concept can apply to any smart device in the household that has Wi-Fi connectivity. In this illustration the multiple access points (AP's) 402A-402C gather Wi-Fi signal data from the client 406 such as signal strengths between client Wi-Fi devices 408 and all AP nodes. It should be noted that Wi-Fi signals attenuate with distance and when traveling through walls and other objects, various objects such as walls, doors, mirrors, and clients all interfere and attenuate Wi-Fi signals leading to varied Received Signal Strength Indicators (RSSI). As shown the RSSI data (attenuation shown in negative dB) can be measured and gathered by the AP's 402 and provided to the servers 20 in the cloud 12 which perform an algorithm to matrix the signal data from the APs, and correlate with the signal data from the smart device. The RSSI data from multiple AP's can be used to locate the client 406 based on signal strengths from the clients Wi-Fi enabled device 408 at the multiple AP's. The controller would than identify the AP closest to the smart device and control the appropriate smart device 404A-404I. In this illustration the client 406 with the network enabled Wi-Fi device 408 moves in the direction of or into a room in the household, the APs detect the client Wi-Fi enabled device 408 by measuring RSSI from multiple AP's. However, other signal data can be used in the algorithm to locate clients and client Wi-Fi devices such as a plurality of RSSI, capacity, load, error rates, delays, interference, and fractions of time spent transmitting and receiving. The measured data is directed to the servers 20 in the cloud 12, where an algorithm is performed to pinpoint the clients location. The algorithm than identifies the AP that is closest to the smart device (402C) as the smart device has already been identified in the household by the Client using an App, and for this example would send Wi-Fi signals to the lighting controller (404B) and turn on the light in the room. This process can be applied where the client has been detected in the same room or is being detected as moving into the room as movement of the Wi-Fi enabled device 408 can be measured and tracked via the cloud-based controller by sampling the signal data over time. The movement of the Wi-fi enabled device 408 can be correlated with client movement 406, so stationary Wi-Fi enabled devices will not be helpful in predicting client movement, therefore, those devices such as televisions, desktop computers, etc. can be excluded from the algorithm automatically by historical observation of Wi-Fi signals over time (i.e. movement has not been detected for some time).

This process will utilize an Application Programming Interface (API), which is a set of software protocols for building and integrating access data and features of other application, servers, or operating systems. An API will allow multiple devices to communicate with one another and will enable the locating and control process to access data from multiple smart devices and multiple Wi-Fi enabled devices that may operate on different platforms created by different applications. The API would send instructions between software platforms without having to fully migrate into the different device ecosystems which is an important feature as smart devices and Wi-Fi device architecture is not universally standardized. The API would allow usage of data across the network in the quickest, easiest, and most efficient way.

This process of locating a client can be further customized to identifying a specific client when multiple clients are present in the household or environment. Once a specific client is identified, specific customized smart device controls can be applied. Implementing the identification of a specific client in a multi-client environment can be further detailed as follows:
Enabling the client to report what device they are carrying by using a mobile app.
Using processes, algorithms, functions, and techniques to interpret the client by recognizing the client hostname or nickname on the device.
Historical observation of client behaviors and correlating those client behaviors with the Wi-Fi enabled device by utilizing processes, algorithms, functions, and techniques. For instance, if a Wi-Fi enabled device leaves and enters the home at a consistent time on certain days of the week the process could identify the client associated with the Wi-Fi enabled device.
   Alternatively, there may exist functions that are not dependent on a specific client but dependent on any client in the environment which could be generalized in the algorithm, such as if any device or any client is detected in a room or detected as moving into a room, turn the smart lights on. There also may exist functions that are based on an overall environment change, such as if the last client to be detected in the household leaves the home, smart device control can be initiated, such as set the security alarm, turn off the lights, or modify the setpoints for the smart thermostat.

Locating the client Wi-Fi enabled device carried by the client can consist of but not be limited to the following processes:
Determining static location of the client by Wi-Fi signal identification
Determining motion of the client by Wi-Fi signal identification over time
Determining which AP the client device is associated with
Triangulating the client by sending data to and from the clients Wi-Fi enabled device that are timestamped by multiple Wi-Fi AP's. Triangulation refers to the method of locating a transmitting device by using at least three receivers and creating spheres of measurements around each receiving device. The location of the transmitting device can be determined by detecting the transmitting device from all the receivers based on the intersection of the spheres in the environment, and using the detecting data (distance, time, etc.) to triangulate the distance by knowing the distance between the transmitting device and all three receivers. The triangulation can be calculated as vectors with different signal strengths. Some triangulation techniques are as follows:
   Triangulating using IEEE 802.11 standards by measuring the RSSI signal strength.
   Triangulation based on time of arrival (ToA), time difference of arrival (TDOA), frequency difference of arrival (FDOA) or other measurement of delay at the AP. ToA is a method of measuring distance by knowing the exact time that a signal was sent from a transmitter to a receiver, the exact time the signal was received at the receiver, and the velocity of the signal. The time span elapsed since the time of transmission (ToT) is the time of flight (TOF). The TDOA is the difference between the ToAs measured on pairs of paths, which only requires the time that the signal was sent from the transmitter and the velocity of the signal. The FDOA is analogous to the TDOA but uses the doppler shift of the signal due to disparities between the transmitter and receiver velocities. The time and frequency delays described above can be used together to improve location accuracy. The measurements between a transmitter and receiver can be represented by a sphere with the center of the measurement sphere at the transmitter. With a minimum of three transmitters, the geometric intersection of the three or more spheres can represent a distinct intersection point which locates the receiver. With the AP representing the transmitter and the Client or Client Wi-Fi devices representing the receiver this trilateration or multi-lateration method can be applied to locating a client Wi-Fi enabled device in a Wi-Fi network environment.
Matching Wi-Fi signal strength vector from the client Wi-Fi device to that measured by the AP's for the smart device. The AP's would measure the signal strength vector from the client Wi-Fi device and compare that to the signal strength vectors from the smart devices in the environment.
   Matching Wi-Fi signal strength vector has a controllable margin of error or required degree of similarity between the signals to the client Wi-Fi device and the smart devices. The margin of error would defined and refined in the algorithm.
Matching of ToA, TDOA, or other delay to those coming from the smart device
   Matching Wi-Fi delay vector has a controllable margin of error or required degree of similarity.
Enhancing prediction of location using historical data and machine learning.
   Learning the patterns of where devices typically move and making that a likely “match” for the location algorithm.
Learning the signal strengths or delays/ToA of a clients Wi-Fi enabled device vs. the manual operation of a smart device (e.g. control on/off of light by light switch, enabling/disabling smart electrical outlet). In effect this will determine where the control interfaces or typical location for control of a smart device, and therefore using the control point as a proxy for the smart device's actual location.
Manually mapping the environment with help from the client. This would require the client to move around the environment and provide feedback about which room the client is moving in by using a mobile app. Each room gets mapped for signal strengths or delays/ToA, and this mapping is stored and matched later to determine the room that a client is in, and therefore determine what smart device is applicable to that room.
Angle of Arrival (AoA), also known as Direction of Arrival (DoA) can be used to determine the location of the device. AoA is based on the principle of measuring angular estimation between a transmitter and receiver placed at a certain location at a certain angle. By using two AoAs and the receiver position, the coordinates of the transmitter can be determined by triangulation being calculated by algorithms. To measure AoA two or more antennas are required, therefore this can work well in a Multiple-Input Multiple-Output (MIMO) device that has multiple antennas.

Locating the client independent of the Wi-Fi enabled device carried by the client by using the interruption of a client on Wi-Fi signals (Wi-Fi motion detection) can consist of but not be limited to the following processes:
Determining the client location by measuring signal interruption between the AP's while the client is in motion. As a person's body disturbs the Wi-Fi signal in an environment, the AP's can gather signal data associated with that disturbance based on the environment that has been mapped by the controlling algorithm (measured Wi-Fi signals vs. previously recorded Wi-Fi signals).
Determining the client location by measuring signal interruption between the AP's and the client in the environment while the client is in motion.
   This method would compare the current measured motion to previously recorded motions near each of the smart devices and use the degree of matching algorithm to compare and match the measured signal vectors to the previously recorded vectors. This can be learned by manually mapping the environment with help from the client, for instance the client would move near each smart device they desire to control and identify the device via the app. The detection of Wi-Fi signal interruption while the client is moving around the environment near the smart device can be modeled and stored for future motion detection. This could also be completed by observing the relationship of motion at the client smart device manual control by receiving data on the client motion, location of client, location of smart device, and smart device operational feedback. For instance, if motion is detected from a location in the environment to the known location of a smart device, and the smart device is turned on, that data could be used to predict future operation of the smart device in the environment. The correlation of the motion of a client and the location of smart devices in the environment can be used in the algorithm to automatically operate the smart devices.
   The AP's gather Wi-Fi signal data, the cloud-based controller and algorithms sense interruption by significant motion (e.g. a person walking into the room).
   The AP's gather Wi-Fi signal data, the cloud-based controller and algorithms sense interruption by small amounts of motion for detecting presence of a client (e.g. a person breathing).

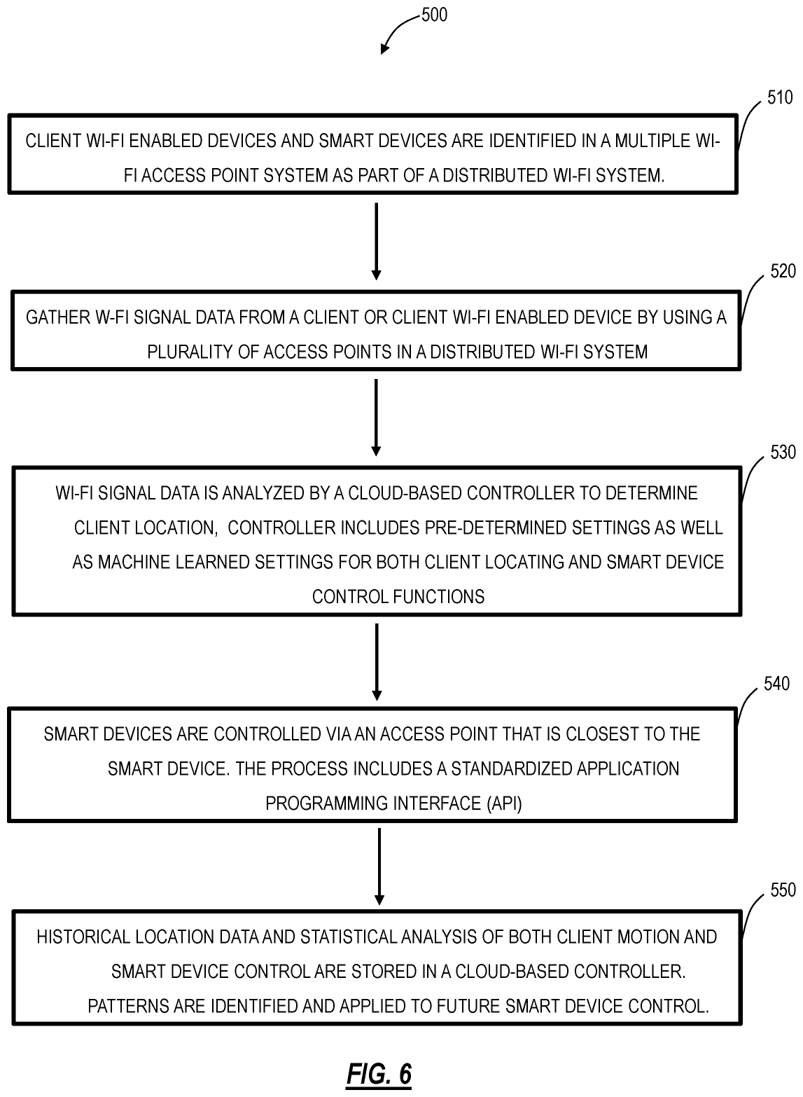

FIG. 6 is a flowchart of the process for locating client or client wi-fi enabled devices in a distributed Wi-Fi network via Wi-Fi signals gathered by AP's and controlling smart devices in the environment 500. The identification of smart devices and client Wi-Fi enabled devices can be by the client using the app, by using algorithms, functions, and techniques to interpret the client by recognizing the client hostname or nickname on the device, or by finding patterns of behavior throughout the environment and associate those behaviors with specific clients 510. New clients that enter the environment would be identified once the Wi-Fi network identifies the Wi-Fi enabled device associated with the new client automatically or through the app. The Wi-Fi signal data is gathered by the plurality of AP's, the data is reported to the cloud 12 and the servers 20 in an event-driven fashion 520. The event driven reporting can be adjusted, and the wi-fi signal data can be triangulated and a comparison of the matrix of signals from the client Wi-Fi device and the smart device can be processed 530. The processed data is used by the cloud controller to determine trends, predictions, and interference in the signal data. The location of the client or client device can be identified by the matrix of signal strengths between nodes and the associated client or client wi-fi device. The time series data can be used to predict future smart device control functions based on client locations and movement. A cloud-based controller is used to analyze the data received from the AP's, the controller determines the location of the client or client Wi-Fi device and identifies the AP that is closest to the smart device 540. A large benefit in system performance can be obtained where the cloud-based controller can identify and choose which AP is closest to the smart device that needs controlled. The learning algorithms that process the Wi-Fi signal data associated with locating smart devices as well as the motion of Wi-Fi enabled devices in the environment can create patterns of behavior which can be used for future automated control of the smart devices 550. The learning algorithms can also be applied to Wi-Fi signal interruption by clients independent of the Wi-Fi enabled device. The combination of client Wi-Fi interruption, client Wi-Fi enabled devices, and smart device location can all be used in the cloud-based controller to map an environment and apply smart device control. These behaviors and patterns can be used for future automatic smart device control by utilizing machine learning.

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Moreover, it is noted that the various elements, operations, steps, methods, processes, algorithms, functions, techniques, etc. described herein can be used in any and all combinations with each other.

What is claimed is:

1. A method comprising steps of:
determining a person's physical location based on analyzing Wi-Fi signal data received from a multiple Wi-Fi access point system as part of a distributed Wi-Fi system; and
controlling smart devices based on one or more of predetermined settings, machine learned settings, and the person's physical location.

2. The method of claim 1, wherein the steps further include determining the person's physical location based on analyzing Wi-Fi client devices that are mobile in the distributed Wi-Fi system.

3. The method of claim 1, wherein the steps further include determining the person's physical location based on disturbance of Wi-Fi signals between a client device and at least one Access Point (AP) or between two APs in the distributed Wi-Fi system.

4. The method of claim 1, wherein the machine learned settings includes using historical location data and statistical analysis to learn patterns of Wi-Fi client devices.

5. The method of claim 1, wherein an identity of the person is unknown.

6. The method of claim 1, wherein an identity of the person is known and the controlling is specific to the person.

7. The method of claim 1, wherein the steps further include correlating a specific user with a specific Wi-Fi client device.

8. The method of claim 1, wherein the determining is based on monitoring motion of an associated Wi-Fi client device.

9. The method of claim 1, wherein the determining is based on triangulation of the Wi-Fi signal data from a plurality of access points.

10. The method of claim 9, wherein the triangulation is done using one or more of observed Wi-Fi signal strength and observed Wi-Fi time of arrival.

11. The method of claim 1, wherein the determining is based on matching of a signal strength vector within a certain margin of error.

12. The method of claim 1, wherein the determining is based on matching of a time of arrival vector within a certain margin of error.

13. The method of claim 1, wherein the determining is based on matching of a motion disturbance vector within a certain margin of error.

14. The method of claim 1, wherein the determining is based at least partially on training with feedback from the person.

15. The method of claim 14, wherein the feedback includes one or more of
the person indicating their current location at a particular instant, and
the person indicating which mobile client devices are associated specifically with them.

16. The method of claim 1, wherein the machine learned settings include correlating actions on smart devices with the client's physical location.

17. The method of claim 1, wherein the controlling smart devices includes turning a smart device on or off.

18. The method of claim 1, wherein the smart devices include thermostats and the controlling includes setting based on a presence of users.

19. The method of claim 1, wherein the controlling smart devices includes changing a state of an entire house when all people leave or a first person arrives.

20. A non-transitory computer-readable storage medium having computer readable code stored thereon for programming at least one processor to perform steps of:
determining a person's physical location based on analyzing Wi-Fi signal data received from a multiple Wi-Fi access point system as part of a distributed Wi-Fi system; and
controlling smart devices based on one or more of predetermined settings, machine learned settings, and the person's physical location.
